(19) United States
(12) Patent Application Publication
(10) Pub. No.: US 2006/0042404 A1
(43) Pub. Date: Mar. 2, 2006

(54) Magnetostrictive torque sensor and electric steering system

(75) Inventors: Yasuo Shimizu, Kawachi-gun (JP); Yoshito Nakamura, Kawachi-gun (JP); Shunichiro Sueyoshi, Shioya-gun (JP)

Correspondence Address: HAMRE, SCHUMANN, MUELLER & LARSON, P.C., P.O. BOX 2902-0902, MINNEAPOLIS, MN, 55402, US

(73) Assignee: HONDA MOTOR CO., LTD., Tokyo (JP)

(21) Appl. No.: 11/199,914

(22) Filed: Aug. 9, 2005

(30) Foreign Application Priority Data
Aug. 25, 2004 (JP) 2004-245124

(51) Int. Cl. G01L 3/10

(52) U.S. Cl. 73/862.331

(57) ABSTRACT

A magnetostrictive torque sensor includes first and second magnetostrictive films which are provided at a shaft and have different magnetic anisotropies; a first measurement coil and a second measurement coil which face the first magnetostrictive film; and a third measurement coil and a fourth measurement coil which face the second magnetostrictive film. A torque applied to the shaft is measured based on a variation in magnetic characteristics of the first and the second magnetostrictive films; and a failure of the magnetostrictive torque sensor is detected based on a first difference between output values from the first and the second measurement coils and a second difference between output values from the third and the fourth measurement coils. An electric steering system includes the magnetostrictive torque sensor for measuring a steering torque of the system; and an electric motor driven based on the measured magnetostrictive torque for steering the vehicle.

### BACKGROUND OF THE INVENTION

1. Field of the Invention

The present invention relates to a magnetostrictive torque sensor for measuring torque based on a variation in magnetic characteristics due to magnetostriction (or magnetic strain), and relates to an electric steering system having such a magnetostrictive torque sensor.

Priority is claimed on Japanese Patent Application No. 2004-245124, filed Aug. 25, 2004, the content of which is incorporated herein by reference.

2. Description of Related Art

As a contactless magnetostrictive torque sensor, a magnetostrictive torque sensor for measuring torque based on a variation in magnetic characteristics due to magnetostriction is known. Such a magnetostrictive torque sensor is used for measuring a steering torque in a steering system for a vehicle (see Japanese Unexamined Patent Application, First Publication No. 2002-2316658).

FIG. 6 is a diagram for explaining torque measurement using a conventional magnetostrictive torque sensor and failure (or trouble) detection for the magnetostrictive torque sensor. As shown in FIG. 6, magnetostrictive films 91 and 92 having different magnetic anisotropies are provided to a rotation shaft 99, and measurement coils 93 and 94 are respectively made to face the magnetostrictive films 91 and 92 (see Japanese Unexamined Patent Application, First Publication No. S59-164932). In the measurement principle of this magnetostrictive torque sensor 90, when a torque is applied to the rotation shaft 99, magnetic permeabilities of the magnetostrictive films 91 and 92 vary, and accordingly, inductances of the measurement coils 93 and 94 also vary. The torque is measured based on the variations in the inductances.

When such a magnetostrictive torque sensor is used, failure detection for the sensor is necessary when the torque is measured.

When using the above-described magnetostrictive torque sensor 90 having two magnetostrictive films 91 and 92, torque measurement is performed by computing a torque measurement output value VT3 based on the difference between a measurement output of one measurement coil 93 (called the first measurement output value VT1) and a measurement output of the other measurement coil 93 (called the second measurement output value VT2), and failure detection is performed by computing a failure detection output value VTF based on the sum of the first measurement output value VT1 and the second measurement output value VT2 and by comparing the failure detection output value VTF with a specific threshold.

FIG. 7 is a diagram showing output characteristics when the torque measurement output value VT3 is computed based on the following formula (1), and FIG. 8 is a diagram showing output characteristics when the failure detection output value VTF is computed based on the following formula (2).
VT3=k·(VT1−VT2)+V0 (1)
VTF=|VT1+VT2|−C (2)

In the above formulas, k, V0, and C are constants.

Generally, a magnetostrictive film has temperature characteristics in which the higher the temperature, the higher the magnetic permeability. Therefore, in the magnetostrictive torque sensor 90, when the magnetic permeabilities of the magnetostrictive films 91 and 92 vary according to a variation in temperature (i.e., a temperature variation), the first measurement output value VT1 and the second measurement output value VT2 of the measurement coils 93 and 94 also vary. If the first and second measurement output values VT1 and VT2 vary as shown by the dashed lines in FIG. 7 due to a temperature variation, the torque measurement output value VT3 is scarcely affected by the temperature variation because VT3 is the difference between the first and second measurement output values VT1 and VT2. Therefore, in this case, the torque measurement output value VT3 is accurate even when there is a temperature variation.

However, the failure detection output value VTF is the sum of the first and second measurement output values VT1 and VT2. Therefore, when VT1 and VT2 vary as shown by the dashed lines in FIG. 8 due to a temperature variation, the failure detection output value VTF is also affected by the temperature variation. Accordingly, the failure detection output value VTF may exceed (or deviate from) a failure detection threshold range A (see the bold dashed line in FIG. 8), and it is determined that the torque sensor is out of order failure even when the sensor normally operates.

In addition, when the above-described magnetostrictive torque sensor is mounted in a vehicle and the magnetic field in the vehicle interior changes due to a magnet built in a road or to activation of an actuator (e.g., a starter motor) using a large current, the first measurement output value VT1 and the second measurement output value VT2 may vary. FIG. 9 is a diagram showing output characteristics for torque measurement using a conventional magnetostrictive torque sensor, so as to explain influence of variation in the magnetic field. When the first measurement output value VT1 and the second measurement output value VT2 vary as shown by the dashed lines in FIG. 9 due to a variation in the magnetic field, the torque measurement output value VT3 is scarcely affected by the variation in the magnetic field because VT3 is the difference between the first and second measurement output values VT1 and VT2. Therefore, in this case, the torque measurement output value VT3 is accurate even when there is a variation in the magnetic field.

However, the failure detection output value VTF is the sum of the first and second measurement output values VT1 and VT2. FIG. 10 is a diagram showing an example of a variation in the output value when the magnetic field varies. FIG. 11 is a diagram showing output characteristics for failure detection using a conventional magnetostrictive torque sensor, so as to explain the influence of variation in the magnetic field. When VT1 and VT2 vary as shown by the dashed lines in FIG. 11 due to a variation in the magnetic field, the failure detection output value VTF is also affected by the variation in the magnetic field. Accordingly, the failure detection output value VTF may exceed a failure detection threshold range A (see FIG. 10 and the bold dashed line in FIG. 11), and it may be determined that the torque sensor is out of order even when the sensor is operating normally.

### SUMMARY OF THE INVENTION

In light of the above circumstances, an object of the present invention is to provide a magnetostrictive torque sensor for performing failure detection without influence of a variation in the temperature or the magnetic field, and to provide a highly-reliable electric steering system having such a magnetostrictive torque sensor.

Therefore, the present invention provides a magnetostrictive torque sensor (e.g., a magnetostrictive torque sensor 30 in an embodiment explained later) comprising:

a first magnetostrictive film (e.g., a first magnetostrictive film 31 in the embodiment) and a second magnetostrictive film (e.g., a second magnetostrictive film 32 in the embodiment), which are provided at a shaft (e.g., a steering shaft 1 in the embodiment) and have different magnetic anisotropies;

a first measurement coil (e.g., a first measurement coil 33 in the embodiment) and a second measurement coil (e.g., a second measurement coil 34 in the embodiment) which face the first magnetostrictive film; and

a third measurement coil (e.g., a third measurement coil 35 in the embodiment) and a fourth measurement coil (e.g., a fourth measurement coil 36 in the embodiment) which face the second magnetostrictive film, wherein:

a torque applied to the shaft is measured based on a variation in magnetic characteristics of the first and the second magnetostrictive films; and

a failure of the magnetostrictive torque sensor is detected based on a first difference between output values from the first and the second measurement coils and a second difference between output values from the third and the fourth measurement coils.

The failure of the magnetostrictive torque sensor may be detected (i) when at least one of the first difference and the second difference exceeds a predetermined threshold range, (ii) when the sum of the first difference and the second difference exceeds a predetermined threshold range, or (iii) when a difference between the first difference and the second difference exceeds a predetermined threshold range.

In a typical example, the torque applied to the shaft is measured based on (i) one of a third difference between output values from the first and the third measurement coils, and a fourth difference between output values from the second and the fourth measurement coils, or (ii) a difference between a third difference between output values from the first and the third measurement coils and a fourth difference between output values from the second and the fourth measurement coils.

According to the above structure, it is possible to cancel a variation in magnetic characteristics due to a variation in the temperature or the magnetic field, thereby performing failure detection of the magnetostrictive torque sensor with high accuracy without the measurement being affected by a variation in the temperature or the magnetic field. Therefore, reliability of the magnetostrictive torque sensor can be improved.

The present invention also provides an electric steering system for a vehicle, comprising:

a magnetostrictive torque sensor as described above, for measuring a steering torque of the steering system;

an electric motor for steering the vehicle; and

a control device for driving the electric motor based on the measured magnetostrictive torque.

According to the above structure, it is possible to prevent erroneous determination due to a variation in the temperature or the magnetic field that the magnetostrictive torque sensor for measuring the steering torque of the electric steering system is out of order though the sensor is not actually out of order, thereby improving reliability of the electric steering system.

### BRIEF DESCRIPTION OF THE DRAWINGS

FIG. 1 is a diagram showing the general structure of an electric power steering system having a magnetostrictive torque sensor according to the present invention.

FIG. 2 is a diagram showing output characteristics of the first and the second measurement coils of the magnetostrictive torque sensor.

FIG. 3 is a diagram showing output characteristics of the third and the fourth measurement coils of the magnetostrictive torque sensor.

FIG. 4 is a diagram showing output characteristics in torque measurement using the magnetostrictive torque sensor.

FIG. 5 is a diagram showing output characteristics in failure detection for the magnetostrictive torque sensor.

FIG. 6 is a diagram for explaining torque measurement using a conventional magnetostrictive torque sensor and failure detection for the magnetostrictive torque sensor.

FIG. 7 is a diagram showing output characteristics in torque measurement using the conventional magnetostrictive torque sensor, so as to explain influence of variation in the temperature.

FIG. 8 is a diagram showing output characteristics in failure detection for the conventional magnetostrictive torque sensor, so as to explain influence of variation in the temperature.

FIG. 9 is a diagram showing output characteristics in torque measurement using the conventional magnetostrictive torque sensor, so as to explain influence of variation in the magnetic field.

FIG. 10 is a diagram showing an example of a variation in the output value of the conventional magnetostrictive torque sensor when the magnetic field varies.

FIG. 11 is a diagram showing output characteristics in failure detection for the conventional magnetostrictive torque sensor, so as to explain influence of variation in the magnetic field.

### DETAILED DESCRIPTION OF THE INVENTION

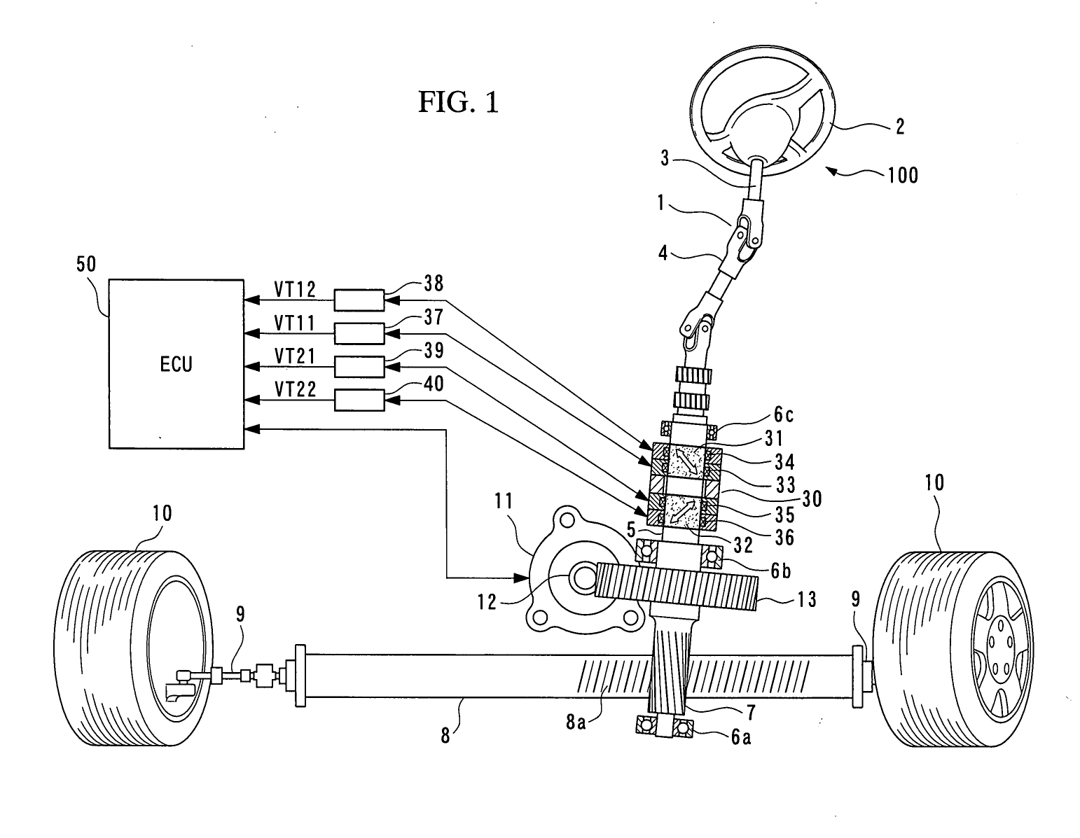

Hereinafter, embodiments of a magnetostrictive torque sensor and an electric steering system having the magnetostrictive torque sensor, according to the present invention, will be described with reference to FIGS. 1 to 5.

FIG. 1 is a diagram showing the general structure of an electric power steering system having a magnetostrictive torque sensor according to the present invention. As shown in FIG. 1, the electric power steering system 100 (i.e., an electric steering system of the present invention) for a vehicle has a steering shaft 1 coupled with a steering wheel 2 (i.e., a steering device). The steering shaft 1 consists of a main steering shaft 3 integrally coupled with the steering wheel 2 and a pinion shaft 5 at which a pinion 7 of a rack and pinion mechanism is provided. The main steering shaft 3 and the pinion shaft 5 are coupled with each other via a universal joint 4.

A lower portion, an intermediate portion, and an upper portion of the pinion shaft 5 are respectively supported by bearings 6a, 6b, and 6c, and the pinion 7 is attached to a lower end of the pinion shaft 5. The pinion 7 engages with a rack (teeth) 8a of a rack shaft 8 which can perform reciprocation in the width of the vehicle. To either end of the rack shaft 8, right and left front wheels 10 are coupled as steered wheels via tie rods 9. According to the above structure, an ordinary rack and pinion steering operation can be performed by operating the steering wheel 2, thereby steering the front wheels 10 and turning the vehicle. The rack shaft 8, the rack 8a, and the tie rods 9 constitute a steering mechanism.

The electric power steering system 100 also includes an electric motor 11 for supplying assistant steering power so as to reduce the steering power generated by the steering wheel 2. A worm gear 12 provided at an output shaft of the electric motor 11 engages with a worm wheel gear 13 provided below the intermediate bearing 6b at the pinion shaft 5.

Between the intermediate bearing 6b and the upper bearing 6c at the pinion shaft 5, a magnetostrictive torque sensor 30 is provided, which measures torque based on a variation in magnetic characteristics due to magnetostriction.

The magnetostrictive torque sensor 30 generally has (i) a first magnetostrictive film 31 and a second magnetostrictive film 32, each having an annular form along the whole circumference on the outer peripheral surface of the pinion shaft 5, (ii) a first measurement coil 33 and a second measurement coil 34 which face the first magnetostrictive film 31, (iii) a third measurement coil 35 and a fourth measurement coil 36 which face the second magnetostrictive film 32, and (iv) measurement circuits 37, 38, 39, and 40 which are respectively connected to the first, second, third, and fourth measurement coils 33, 34, 35, and 36.

The first and second magnetostrictive films 31 and 32 are metal films made of a material which exhibits a large variation in permeability under strain. For example, each film may be a Ni—Fe alloy film formed at the outer periphery of the pinion shaft 5 by plating.

The first magnetostrictive film 31 has magnetic anisotropy in a direction inclined by approximately 45 degrees from the axis of the pinion shaft 5, and the second magnetostrictive film 32 has magnetic anisotropy in a direction inclined by approximately 90 degrees from the direction of the magnetic anisotropy of the first magnetostrictive film 31. Therefore, magnetic anisotropies of the first and second magnetostrictive films 31 and 32 have a phase difference of approximately 90 degrees.

The first measurement coil 33 and the second measurement coil 34 are coaxially arranged around the first magnetostrictive film 31, where a specific gap is provided between the coils and the magnetostrictive film, and positions of the coils are different along the axis of the pinion shaft 5.

The third measurement coil 35 and the fourth measurement coil 36 are coaxially arranged around the second magnetostrictive film 32, where a specific gap is provided between the coils and the magnetostrictive film, and positions of the coils are different along the axis of the pinion shaft 5.

According to the above-described magnetic anisotropies of the first and second magnetostrictive films 31 and 32, when a torque is applied to the pinion shaft 5, compressive force is applied to one of the first and second magnetostrictive films 31 and 32, and tensile force is applied to the other of the first and second magnetostrictive films 31 and 32. As a result, the permeability of one of the magnetostrictive films increases while the permeability of the other magnetostrictive film decreases. Accordingly, the inductances of the two measurement coils arranged around said one of the magnetostrictive films increase while the inductances of the two measurement coils arranged around the other of the magnetostrictive films decrease.

The first, second, third, and fourth measurement coils 33, 34, 35, and 36 are connected to the measurement circuits 37, 38, 39, and 40 which respectively have conversion circuits. In the measurement circuits 37, 38, 39, and 40, variations in the inductance of the measurement coils 33, 34, 35, and 36 are converted to voltage variations which are output to an electronic control unit (ECU) 50.

Based on the voltages output from the measurement circuits 37 to 40, the ECU 50 performs measurement of steering torque applied to the pinion shaft 5 and failure (or trouble) detection of the magnetostrictive torque sensor 30. Below, the method of computing a torque measurement voltage VT3 and a failure detection voltage VTF in the present embodiment will be explained.

Here, voltages output from the measurement circuits 37, 38, 39, and 40 are respectively called VT11, VT12, VT21, and VT22.

In order to measure the torque measurement voltage VT3, first, (i) differential voltages VT31 and VT32 are computed using formulas (3) and (4), or (ii) differential voltages VT31 and VT33 are computed using formulas (3) and (5).
VT31=VT11−VT21+V0=k11·T−(−k21·T)=(k11+k21)T (3)
VT32=VT12−VT22+V0=k12·T−(−k22·T)=(k12+k22)T (4)
VT33=VT22−VT12+V0=−k22·T−(k12·T)=−(k12+k22)T (5)

In the above formulas, k11, k12, k21, and k22 are proportional constants, V0 is a constant, and T indicates a steering torque.

Therefore, the differential voltage VT31 is a differential voltage (i.e., a differential output value) between the first measurement coil 33 facing the first magnetostrictive film 31 and the third measurement coil 35 facing the second magnetostrictive film 32, and the differential voltage VT32 and the differential voltage VT33 are differential voltages (i.e., differential output values) between the second measurement coil 34 facing the first magnetostrictive film 31 and the fourth measurement coil 36 facing the second magnetostrictive film 32.

As the torque measurement voltage VT3, one of VT31 and VT32 is used. In formula (3), k11 and k21 are almost equal; thus, VT31 has a gain approximately twice the gain of VT11 or VT21 for measuring the steering torque T. Similarly, in formula (4), k12 and k22 are almost equal; thus, VT32 has a gain approximately twice the gain of VT12 or VT22 for measuring the steering torque. According to the doubled gain, sensitivity is also doubled.

In another method, the torque measurement voltage VT3 can be computed based on a difference between the differential voltages VT31 and VT33, by the following formula (6).
VT3=VT31−VT33+V0=(k11+k12+k21+k22)T (6)

According to formula (6), VT3 is effective for quadrupling the sensitivity in comparison with VT11 to VT22.

In computation of the failure detection voltage VTF, first, differential voltages VTF1 and VTF2 are computed by the following formulas (7) and (8).
VTF1=VT11−VT12 (7)
VTF2=VT21−VT22 (8)

That is, the differential voltage VTF1 (i.e., the first differential signal) is a differential voltage (i.e., a differential output value) between the first measurement coil 33 and the second measurement coil 34 which face the first magnetostrictive film 31, and the differential voltage VTF2 (i.e., the second differential signal) is a differential voltage (i.e., a differential output value) between the third measurement coil 35 and the fourth measurement coil 36 which face the second magnetostrictive film 32.

When at least one of VTF1 and VTF2 exceeds (or deviates from) a failure detection threshold range A, it is determined that the sensor is out of order.

In another method, a failure detection voltage VTF3 is computed by the sum or the difference of the differential voltages VTF1 and VTF2 by the following formula (9) or (10).
VTF3=VTF1+VTF2 (9)
VTF3=VTF1−VTF2 (10)

In this case, when VTF3 exceeds from the failure detection threshold range A, it is determined that the sensor is out of order.

According to the measured torque measurement voltage VT31, VT32, or VT33, the ECU 50 sets a target current of the electric motor 11, and drives the electric motor 11 at the target current so as to generate assistant steering power and to steer the vehicle. In addition, when the failure detection output value VTF1, VTF2, or VTF3 exceeds the predetermined threshold range A, the ECU50 determines that the magnetostrictive torque sensor 30 is out of order.

The first magnetostrictive film 31 and the second magnetostrictive film 32 have a temperature characteristic in which the higher the temperature, the higher the permeability. Therefore, even when the same torque is applied to the pinion shaft 5, the voltages VT1, VT2, VT3, and VT4, which are respectively output from the measurement circuits 37, 38, 39, and 40, vary according to a temperature variation.

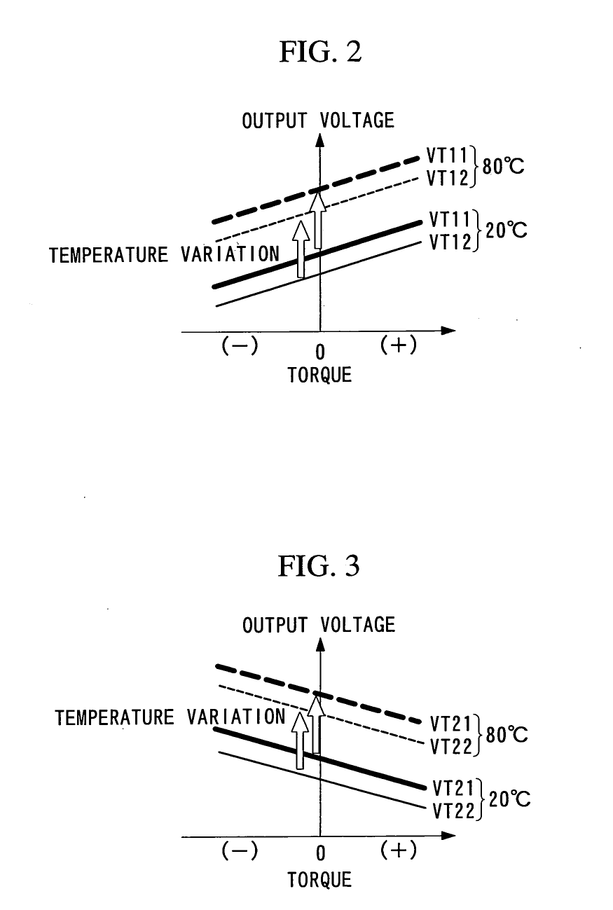

FIG. 2 is a diagram showing output characteristics of the output voltages VT11 and VT12 from the measurement circuits 37 and 38 which respectively correspond to the first and the second measurement coils 33 and 34 for the first magnetostrictive film 31. In FIG. 2, solid lines show characteristics at a temperature of 20° C., and dashed lines show characteristics at a temperature of 80° C.

FIG. 3 is a diagram showing output characteristics of the output voltages VT21 and VT22 from the measurement circuits 39 and 40 which respectively correspond to the third and the fourth measurement coils 35 and 36 for the second magnetostrictive film 32. In FIG. 3, solid lines show characteristics at a temperature of 20° C., and dashed lines show characteristics at a temperature of 80° C.

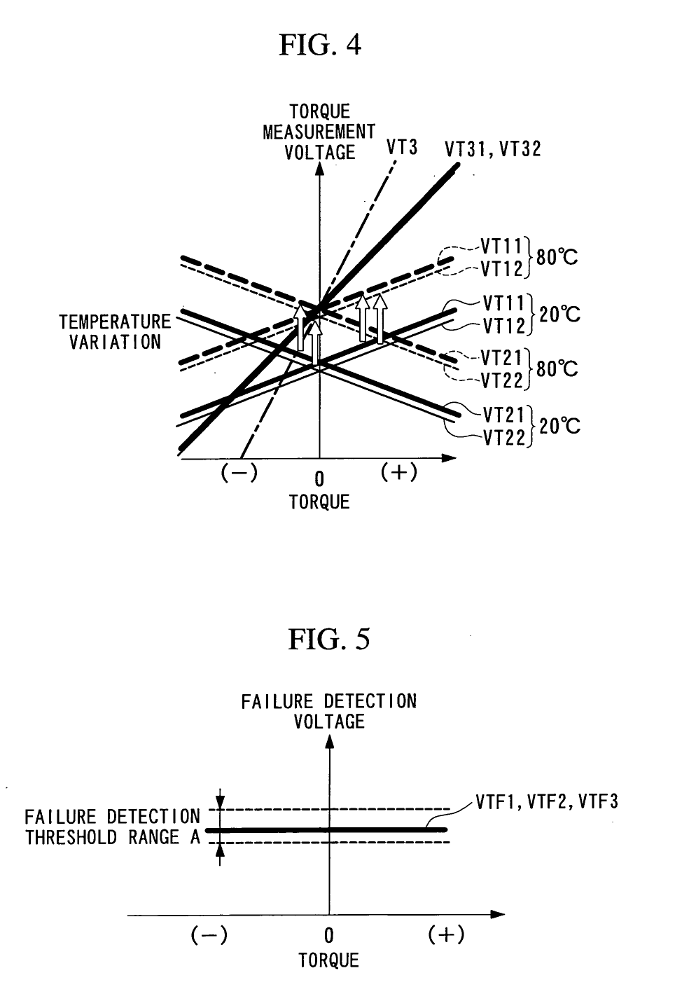

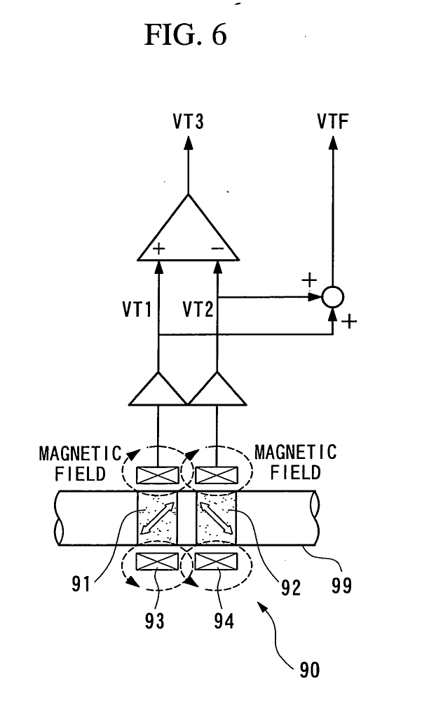

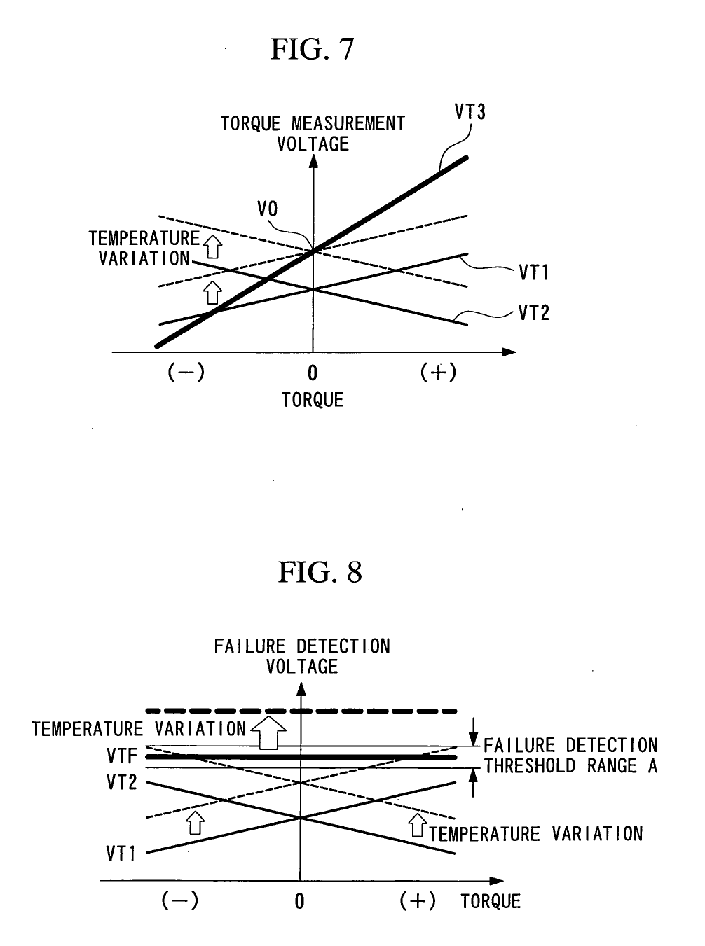

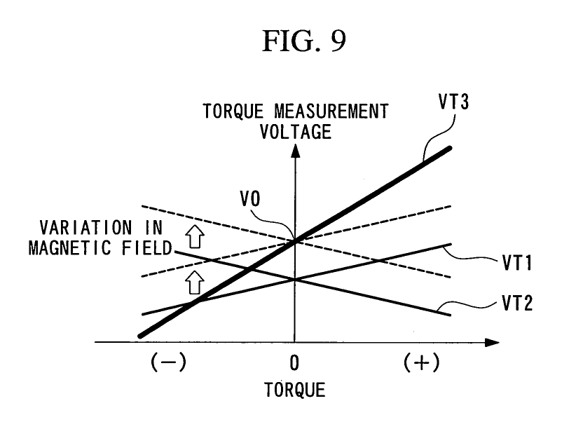

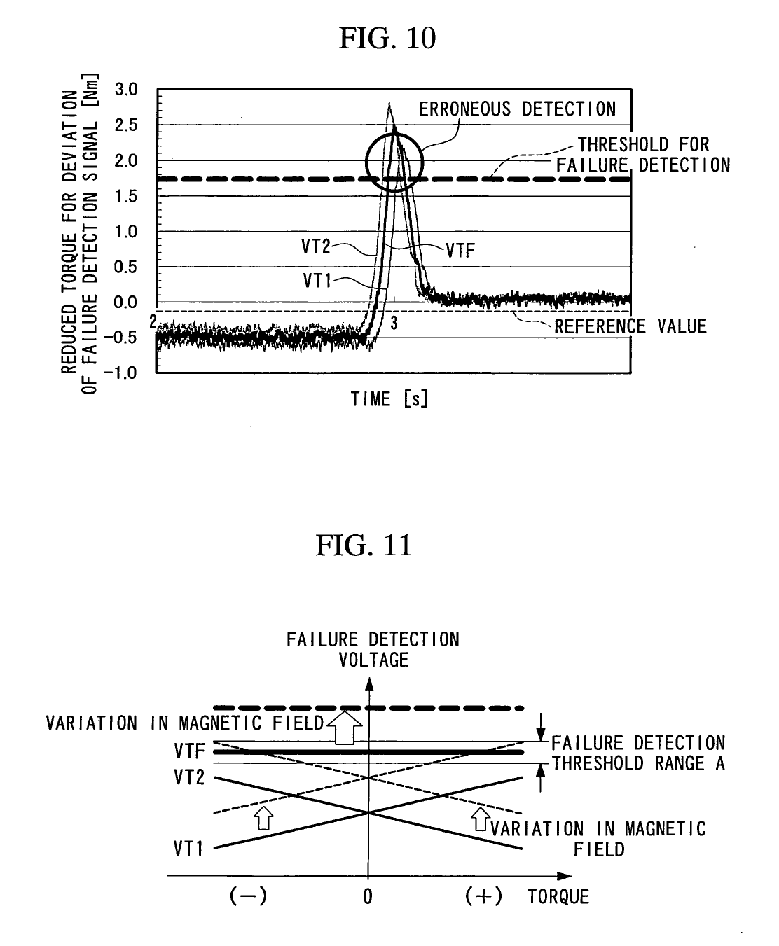

FIG. 4 is a diagram showing output characteristics of the torque measurement voltages VT31, VT32, and VT3, in which the output voltages VT11 and VT12 and the output voltages VT21 and VT22 are shown in the same graph. As shown in this diagram, the output voltages VT11, VT12, VT21, and VT22 vary depending on the temperature; however, the differential voltage VT31 between the output voltages VT11 and VT21 and the differential voltage VT32 between the output voltages VT12 and VT22 do not vary when the temperature varies. Therefore, the torque measurement voltage VT3, which is the differential voltage VT31 or VT32, or the differential voltage between VT31 and VT32, also does not vary when the temperature varies. Accordingly, in the electric power steering system 100, torque applied to the pinion shaft 5 can be measured with high accuracy without the measurement being affected by a variation in magnetic characteristics due to a temperature variation.

In addition, the output voltages VT11 and VT12 vary according to a temperature variation, as shown in FIG. 2; however, the differential voltage VTF 1 between the output voltages VT11 and VT12 does not vary when the temperature varies. Similarly, the output voltages VT21 and VT22 vary according to a temperature variation, as shown in FIG. 3; however, the differential voltage VTF2 between the output voltages VT21 and VT22 does not vary when the temperature varies. That is, as shown in FIG. 5 (which is a diagram showing output characteristics of the magnetostrictive torque sensor 30 for failure detection), the differential voltage VTF1 or VTF2 does not vary when the temperature varies. In addition, the failure detection voltage VTF3 which is the sum or the difference of the differential voltages VTF1 and VTF2 also does not vary when the temperature varies. As a result, in the electric power steering system 100, failure detection for the magnetostrictive torque sensor 30 can be performed with high accuracy without the measurement being affected by a variation in magnetic characteristics due to a temperature variation. Accordingly, it is possible to prevent erroneous determination (due to a temperature variation) that the magnetostrictive torque sensor 30 is out of order when the sensor is not actually out of order.

In addition, when the measurement voltages VT11, VT12, VT21, and VT22 of the measurement circuits 37 to 40 vary due to a variation in the magnetic field, functions and effects are similar to those observed when there is a temperature variation. That is, also in this case, the torque measurement voltage VT31, VT32, or VT3 is computed by the above-described formula (3), (4), or (6), and the failure detection voltage VTF1, VTF2, or VTF3 is computed by the above-described formula (7), (8), (9) or (10). Therefore, torque applied to the pinion shaft 5 can be measured with high accuracy and failure detection for the magnetostrictive torque sensor 30 can be performed with high accuracy without the measurement being affected by a variation in the magnetic field. Accordingly, it is possible to prevent erroneous determination (due to a variation in the magnetic field) that the magnetostrictive torque sensor 30 is out of order though the sensor is not actually out of order.

In the above embodiment, the failure detection voltage VTF1 is computed as the difference (or the differential voltage) between the measurement voltages VT11 and VT12, and the failure detection voltage VTF2 is computed as the difference (or the differential voltage) between the measurement voltages VT21 and VT22, and the failure detection voltage VTF3 is computed as the sum or the difference of the differential voltages VTF1 and VTF2. However, instead of the above computation, the ratio of the measurement voltage VT11 to VT12 (i.e., VT11/VT12) and the ratio of the measurement voltage VT21 to VT22 (i.e., VT21/VT22) may be computed, and product of these two ratios may be computed as a failure detection output value. Based on this failure detection output value, failure detection for the magnetostrictive torque sensor 30 may be performed.

In another variation, the first magnetostrictive film 31 is divided into two portions along the axis of the pinion shaft 5, and one of the two portions is dedicatedly used as a magnetostrictive film for the first measurement coil 33, and the other is dedicatedly used as a magnetostrictive film for the second measurement coil 34. Similarly, the second magnetostrictive film 32 is divided into two portions in the axial direction of the pinion shaft 5, and one of the two portions is dedicatedly used as a magnetostrictive film for the third measurement coil 35, and the other is dedicatedly used as a magnetostrictive film for the fourth measurement coil 36. Therefore, an arrangement using four magnetostrictive films is possible.

In the computation for the failure detection output value of the magnetostrictive torque sensor 30, based on the differential voltages VT31 and VT32 which are computed by the above-described formulas (3) and (4), a failure detection voltage VTF4 may be computed by the following formula (11) (for computing the difference between VT31 and VT32), and it may be determined that the magnetostrictive torque sensor 30 is out of order when the failure detection voltage VTF4 exceeds a specific threshold B.
VTF4=VT31−VT32 (11)

When failure detection is performed based on the failure detection voltage VTF4, failure detection for the magnetostrictive torque sensor 30 can also be performed with high accuracy without the measurement being affected by a variation in the temperature or the magnetic field.

As described above, the differential voltage VT31 is a differential voltage between the first measurement coil 33 facing the first magnetostrictive film 31 and the third measurement coil 35 facing the second magnetostrictive film 32, and the differential voltage VT32 is a differential voltage between the second measurement coil 34 facing the first magnetostrictive film 31 and the fourth measurement coil 36 facing the second magnetostrictive film 32.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

For example, the present invention is not restrictively applied to an electric power steering system as described in the above embodiment, and may be applied to a steering system for a vehicle, which employs a steering by wire system. In the steering by wire system, a steering device is mechanically separated from a steering mechanism, and a steering motor provided at the steering mechanism is driven according to steering torque applied to the steering device, so as to steer the steered wheels of the vehicle. The magnetostrictive torque sensor according to the present invention can be used for measuring the steering torque applied to the steering device in this system.

What is claimed is:

1. A magnetostrictive torque sensor comprising:
a first magnetostrictive film and a second magnetostrictive film, which are provided at a shaft and have different magnetic anisotropies;
a first measurement coil and a second measurement coil which face the first magnetostrictive film; and
a third measurement coil and a fourth measurement coil which face the second magnetostrictive film, wherein:
a torque applied to the shaft is measured based on a variation in magnetic characteristics of the first and the second magnetostrictive films; and
a failure of the magnetostrictive torque sensor is detected based on a first difference between output values from the first and the second measurement coils and a second difference between output values from the third and the fourth measurement coils.

2. The magnetostrictive torque sensor as claimed in claim 1, wherein the failure of the magnetostrictive torque sensor is detected when at least one of the first difference and the second difference exceeds a predetermined threshold range.

3. The magnetostrictive torque sensor as claimed in claim 1, wherein the failure of the magnetostrictive torque sensor is detected when the sum of the first difference and the second difference exceeds a predetermined threshold range.

4. The magnetostrictive torque sensor as claimed in claim 1, wherein the failure of the magnetostrictive torque sensor is detected when a difference between the first difference and the second difference exceeds a predetermined threshold range.

5. The magnetostrictive torque sensor as claimed in claim 1, wherein the torque applied to the shaft is measured based on one of a third difference between output values from the first and the third measurement coils, and a fourth difference between output values from the second and the fourth measurement coils.

6. The magnetostrictive torque sensor as claimed in claim 1, wherein the torque applied to the shaft is measured based on a difference between a third difference between output values from the first and the third measurement coils and a fourth difference between output values from the second and the fourth measurement coils.

7. An electric steering system for a vehicle, comprising:
a magnetostrictive torque sensor as claimed in claim 1, for measuring a steering torque of the steering system;
an electric motor for steering the vehicle; and
a control device for driving the electric motor based on the measured magnetostrictive torque.
